(19) United States
(12) Patent Application Publication
(10) Pub. No.: US 2020/0055241 A1
(43) Pub. Date: Feb. 20, 2020

(54) Thermal Insulation Fastening System

(71) Applicant: Kolibri Metals GmbH, Amtzell (DE)

(72) Inventors: Christian Prinz, Hergatz (DE); Maximilian Bronner, Berg (DE); Axel Wittig, Wangen (DE)

(21) Appl. No.: 16/543,133

(22) Filed: Aug. 16, 2019

(30) Foreign Application Priority Data
Aug. 17, 2018 (DE) 102018120083.8
Oct. 10, 2018 (DE) 102018124975.6

(51) Int. Cl. B29C 64/245; B29C 64/153; B29C 64/295; B29C 64/255

(52) U.S. Cl. CPC B29C 64/245; B29C 64/153; B33Y 10/00; B29C 64/255; B29C 64/295

(57) ABSTRACT

A device for producing a component using an additive process is disclosed. In an embodiment a device includes an element for producing a component and an assembly for at least partially receiving the element, wherein the component is additively built up on the element, and/or wherein the assembly comprises a putty for thermal insulation and/or fastening of the element.

### CROSS-REFERENCE TO RELATED APPLICATIONS

This application claims priority to German Patent Application No. 102018120083.8, filed on Aug. 17, 2018, and German Patent Application No. 102018124975.6, filed on Oct. 10, 2018, which applications are hereby incorporated herein by reference.

### TECHNICAL FIELD

The present invention relates to a device for additive manufacturing of components or 3D printing, in particular for an SLM process, in which SLM is the abbreviation for selective laser melting.

### BACKGROUND

Selective laser melting (SLM) is a generative manufacturing process, which belongs to the group of beam melting processes. With selective laser melting, the material to be processed is distributed in powder form onto a base plate in a thin layer. By means of laser irradiation the material is melted in the respective locations necessary for producing the desired shape. After the material has solidified, a layer of solid material results. In a next step the base plate/machine table is lowered and newly coated with powder and again exposed to laser irradiation. This cycle is repeated until the finished component is produced. In the end the finished component is cleansed from excess powder and taken off the machine table.

For production of a component a given work space may be used. The work space can be oversized for the desired component, so that a large quantity of powder is necessary in order to carry out the process, however, the biggest part of the powder is not necessary to produce the component itself. Nevertheless said powder is heated by the heating of the component and/or the machine table on which the component is produced and is thus reduced in quality for subsequent production cycles.

### SUMMARY

Embodiments provide a device for producing a component by an additive process, in which only the smallest possible amount of powder is spent and/or becomes unusable.

The additive process may for example be the SLM or SLS process. The SLS process, the abbreviation SLS stands for selective laser sintering, is a generative production process, in which a component is produced layer by layer. In doing so, spatial structures are created from a material in powder form using a laser.

Furthermore, such a device is provided, that the component to be produced is not built up on the machine table but on an assembly, so that the component does not have to be separated from the machine table by a mechanical process, e.g. by disc grinding or sawing.

As first embodiment of the invention a device for producing a component using an additive process is provided, comprising: an element for producing a component and an assembly for at least partially receiving the element, wherein the component is additively built up on the element and/or wherein in the assembly a putty for thermal insulation and/or fastening the element is provided.

By means of the embodiment of the invention by additively printing the component on an element or semi-finished component, a support structure otherwise necessary in additive processes can be omitted.

The device is formed in such a way, that powder which is not needed is isolated from the heated machine table and wherein an element for producing a component is disposed in a receptacle, so that a component may be additively built up on the element, wherein within the device a means may be present, in which the element is at least partially embedded, whereby the element is mechanically supported.

Exemplary embodiments are described in the dependent claims.

According to an also exemplary embodiment of the invention, a device is provided, wherein the element is embedded by the putty and thereby mechanically fastened.

From the element and the component may result a hybrid component. The element may for example have been formed in a non-additive production process, for example by milling or turning. Prior to the start of the additive process the element may be treated with a mixture of various heat-conducting and anti-corrosive additives, in order to ensure that the additive process does not negatively affect the quality of the component.

Furthermore, prior to the start of the process the thermal insulation and/or the fastening putty may be coated with a surface sealing material. This results in the thermal insulation and/or the fastening putty not causing any impurities in the powder (still to be processed) and/or the work space. Because of this impurities can also be avoided in reused powder and consistent component quality can be ensured.

The assembly for installation of the elements may take place on multiple levels. Usually on a machine table a base plate is fastened, which is in direct contact with the elements. Thereby for example a heat transfer from the heatable machine table up to the element is ensured. Thereby temperature may be introduced into the elements in a targeted way.

In a further embodiment an insulating layer, which is implemented by the putty, is disposed between multiple elements and/or the machine table. This is to avoid the potential heating of the non-processed filling powder in the powder bed and at the same time ensure a fastening of the elements.

The putty may be curable, whereby securely fastening and positioning the elements in the work space is ensured.

In a further embodiment a heat conducting foil may additionally be placed between the machine table and the element.

Furthermore a location fit between the element and the heat conducting foil/material/tub may enable an additional positioning/fastening of the element. This serves for the digital model being precisely built up on the element as well as for stress transfer from the element to the heat conducting foil/material/tub.

According to an exemplary embodiment of the invention a device it provided, wherein the putty has a coefficient of thermal expansion which is equal to or higher than that of the element.

In a further exemplary embodiment a device is provided, wherein the coefficient of thermal expansion of the putty is lower than that of the element and/or wherein the coefficient of thermal expansion of the component is different from that of the element.

By means of a higher coefficient of thermal expansion of the putty it is ensured, that the fastening function of the putty with respect to the element is fulfilled.

According to a further exemplary embodiment of the present invention a device is provided, wherein the material properties of the component are inhomogeneous and/or wherein the putty is a compound of a ceramic part and a non-ceramic part.

According to an exemplary embodiment of the invention a device is provided, wherein the process is suited for selective laser melting (SLM) or selective laser sintering (SLS).

In a further embodiment of the invention a device is provided, wherein the device is disposed within the work space of an additive process, wherein the component is produced within the work space.

According to a further exemplary embodiment of the present invention a device is provided, wherein the putty is a thermal insulation, in order to save unprocessed powder from heat during the additive production process.

In a further embodiment according to the invention a device is provided, wherein the element is treated with a mixture of various heat conducting and anticorrosive additives prior to the start of the process and/or wherein the putty is covered with a surface sealing material prior to the start of the process.

Thus it is avoided hat the powder is contaminated by the putty.

According to a further exemplary embodiment of the present invention a device is provided, wherein a location fit between the element and the heat conducting foil/material/tub enables positioning the element and/or wherein a foil is disposed between the element and the component, whereby separating component and element is made easier or unnecessary, because the component and the element are present separately.

In order to reuse any non-melted powder of the additive process, an unintended heating of the powder has to be prevented. By using an additional insulating layer, the powder, which is for example not disposed in close proximity of the elements or the component, can be protected from unintended heat exposure.

It may be considered an embodiment of the invention to provide a device, which reduces the amount of powder spent in an additive process and furthermore facilitates separating the finished component from the machine table.

In a further embodiment of the invention the putty may be formed inhomogeneous with respect to its thermal conductivity, so that a heat exposure of the component occurs in different ways and non-uniform. Thus an inhomogeneous formed component may be produced, which is for example characterized by areas of different toughness and/or hardness.

A further embodiment of the invention is the printing of the component on a thin foil, which is stretched over the element prior to the start of the process. This assembly (element equipped with foil) is, as in the previously described embodiment, fastened in its entirety, by means of the putty, which may be present as a curable putty, to the base plate.

The individual features may of course be combined with each other, whereby in part advantageous effects may result, which surpass the sum of individual effects.

### BRIEF DESCRIPTION OF THE DRAWINGS

Further details and advantaged of the invention will be apparent from the exemplary embodiments illustrated in the drawings, which show

FIG. 1 shows a device for selective laser melting (SLM); and

FIG. 2 shows a device having a measuring system 16 (camera/laser/gauge) for positioning.

### DETAILED DESCRIPTION OF ILLUSTRATIVE EMBODIMENTS

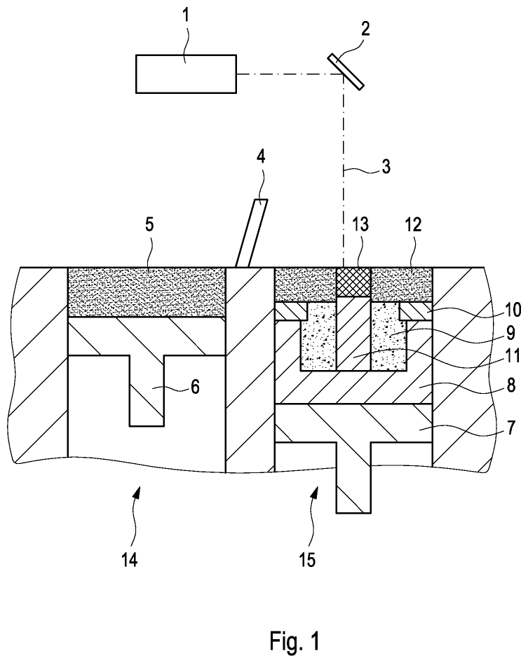

FIG. 1 shows a device for selective laser melting, wherein a powder depot 14 having a lift table 6 is provided. In order to supply a powder 5, the lift table is driven upwards, whereby a metered amount of powder 5 can be transferred by a wiper 4 from the powder depot 14 to the area 15, in which the component is fused by a precisely introduced laser beam. The next layer is created by the machine table 7 being lowered and by the wiper 4 filling a new layer of powder 5 into the resulting depression. By means of a laser 1, a laser irradiation 3 results in certain locations of the powder bed 12. In said locations of the powder bed 12 a molten bath/microstructural change of the powder 5 results, which leads to a solidification after cooling. Thus a component of the desired shape may be produced. After a laser irradiation process the machine table 7 is again lowered and the resulting depression is again filled up with powder from the powder depot 14 by means of the wiper 4. The process is repeated for so long until the component 13 is completed. Next the component 13 is removed from the area 15 and cleansed from powder.

The device comprises a heat conducting mold 8, which can be formed as a tub or a heat conducting foil/material. In the tub 8 an element 11 can be disposed, which can constitute a part of the completed component or which can only be provided for heat conduction to the component 13. In any case the element 11 serves for heat of the machine table 7 being directed to the component 13, so that the additive/SLM/SLS process may be used. The tub 8 is filled with a thermal insulation and/or a bedding putty 9, which is insulating from heat. Furthermore, in addition a thermal insulation and/or a bedding putty 9 may be provided, which is additionally/also heat-insulating. By means of the putty 9, which can be present as a curable composite, it is ensured, that the powder 12, which is not necessary for production of the component 13, is not heated and thus can be reused for subsequent production cycles without reduction in quality.

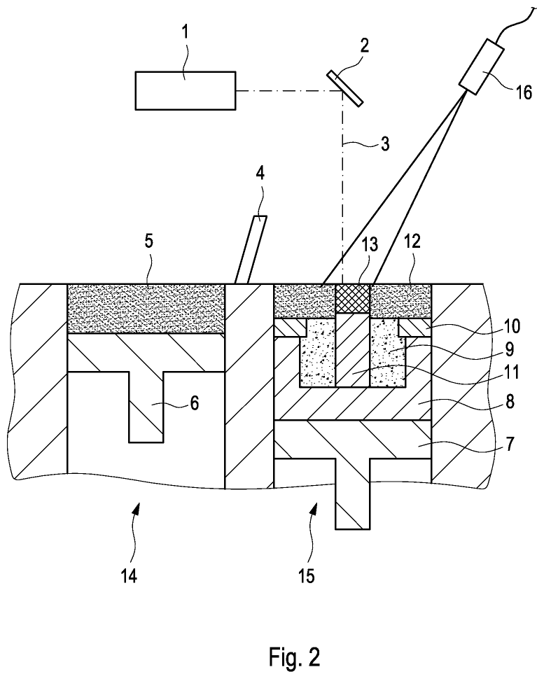

FIG. 2 shows a device, wherein a camera 16 localizes the position of the element 11, so that the mirror 2 can adjust the laser beam 3 in such a way that the component is in fact produced on the element 11, and not next to it, by the additive process.

The advantages of the device result from the powder 12 not being damaged and thus being available for subsequent production processes. Moreover the component 13 is directly applied onto the element 11, which, with the component 13, constitutes the complete component to be created or which can be removed from the component 13 in a simple manner. A complex removal for example by disc grinding the component 13 from the machine table can be omitted.

It shall be mentioned, that the term “comprise” does not preclude additional elements or process steps, just as the term “a” and “an” does not preclude multiple elements and steps.

The reference numerals are used for convenience of understanding only and are not to be considered as limiting, the scope of the invention being indicated by the claims.

### LIST OF REFERENCE NUMERALS

1 laser

2 mirror

3 laser beam

4 wiper

5 powder

6 lift table

7 machine table

8 heat conducting foil/material/tub

9 putty, e.g. a curable putty

11 element/hybrid component (semi-finished component)

12 powder bed

13 component built up in layers

14 powder depot

15 area for producing the desired component

16 camera/laser/gauge

What is claimed is:

1. A device for producing a component using an additive process, the device comprising:
an element for producing the component; and
an assembly for at least partially receiving the element,
wherein
the component is additively built up on the element, and/or
wherein the assembly comprises a putty for thermal insulation and/or fastening of the element.

2. The device according to claim 1, wherein the element is embedded by the putty and therefore mechanically fastened.

3. The device according to claim 1, wherein the putty has a coefficient of thermal expansion which is equal to or higher than that of the element.

4. The device according to claim 1, wherein a coefficient of thermal expansion of the putty is lower than a coefficient of thermal expansion of the element , and/or wherein a coefficient of thermal expansion of the component is different than a coefficient of thermal expansion of the element.

5. The device according to claim 1, wherein material properties of the component are inhomogeneous, and/or wherein the putty is a composite of a ceramic component and a non-ceramic component.

6. The device according to claim 1, wherein the additive process comprises selective laser melting (SLM) or selective laser sintering (SLS).

7. The device according to claim 1, wherein the device is located within a work space of the additive process, and wherein the component is produced within the work space.

8. The device according to claim 1, wherein the putty comprises a thermal insulation configured to preserve unprocessed powder from heat during the additive process.

9. The device according to claim 1, wherein the element is treated with a mixture of various heat conducting and anticorrosive additives, and/or wherein the putty is coated with a surface sealing material prior to starting the additive process.

10. The device according to claim 1, wherein a heat conducting foil/material/tub enables a fastening and/or positioning of the element , and/or wherein a foil is disposed between the element and the component so that the component and the element are separated.
